(19) United States
(12) Patent Application Publication
(10) Pub. No.: US 2009/0284390 A1
(43) Pub. Date: Nov. 19, 2009

(54) Operator's Device for the Detection of a Required Sensor or Actuator, and Corresponding Method

(76) Inventors: Frank Lahner, Arnberg (DE); Peter Thamm, Weinheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/086,404

(22) PCT Filed: Nov. 28, 2006
(86) PCT No.: PCT/EP2006/068992

§ 371 Date: Jun. 12, 2008

(30) Foreign Application Priority Data
Dec. 15, 2005 (DE) 10 2005 060 050.6

(51) Int. Cl. G08B 5/22

(52) U.S. Cl. 340/825.49

(57) ABSTRACT

There is described an operator's device which communicates in a wireless manner with sensors and/or actuators. Positional data of the sensors/actors as well as the ways to get to the same are stored in the memory of the operator's device. Access data is evaluated and displayed in a program and processing unit of the operator's device in order to find a sensor or actuator required in a system when a signal is received.

### CROSS REFERENCE TO RELATED APPLICATIONS

This application is the US National Stage of International Application No. PCT/EP2006/068992, filed Nov. 28, 2006 and claims the benefit thereof. The International Application claims the benefits of German application No. 10 2005 060 050.6 DE filed Dec. 15, 2005, both of the applications are incorporated by reference herein in their entirety.

### FIELD OF INVENTION

The invention relates to an operator's device for the wireless control of sensors and/or actuators, which are distributed in a system and which each comprise a transmit and receive unit, having means for inputting data, a display unit, a storage device as well as a program and processing unit.

The invention also relates to a method for the detection of a required sensor or actuator from several sensors and/or actuators distributed in a system, which each comprise a transmit and receive unit, with the aid of an operator's device which is able to communicate.

### BACKGROUND OF INVENTION

In expanded systems (e.g. refinery, automotive production), it is not always easy to detect sensors or other components, when they are either to be maintained, examined, readjusted or are simply faulty. The reason for this lies in the different scales between expanded systems and small automation components, like for instance sensors and/or actuators. In addition, these sensors and actuators are frequently attached to sites which are not always immediately appreciable.

This object was previously achieved in that maintenance personnel look for the position of the required sensor in the control center on the basis of plans, bear this in mind and then go into the field. If the sensor at the destination cannot be detected immediately, a detailed search is the only form of assistance. If applicable, a layout plan can be taken into the field, e.g. if a number of sensors have to be located one after the other in the case of complicated systems.

Other auxiliary constructions also exist. For instance, in the event of a fault, maintenance personnel in some process control systems are led from the control center of the automation system through switchboards and input/output components to the faulty assembly by means of the displays of red fault light-emitting diodes, which also allows even the sensor or actuator to be reached. However, this is only meaningful in compact electronic compartments, where it is possible to move from one faulty light-emitting diode to the next.

### SUMMARY OF INVENTION

An object underlying the invention is to improve an operator's device of the aforementioned type such that it facilitates the detection of a sensor or actuator from several sensors or actuators distributed in a system.

The object of the invention is also to specify a method for the detection of a required sensor or actuator from several sensors and/or actuators distributed in a system, which also indicates the route to the required sensor or actuator in a simple fashion.

The first object is achieved by an operator's device as claimed in an independent claim. Advantageous developments of the invention can be taken from the subclaims. The further object is achieved by a method as claimed in a further independent claim.

### BRIEF DESCRIPTION OF THE DRAWINGS

An exemplary embodiment of the invention is described in more detail below with reference to a drawing, in which;

FIG. 1 shows a route plan of the system indicating the positions of sensors and/or actuators,

FIG. 2 shows a first item of access information displayed on a display unit for the detection of a required sensor or actuator and

FIG. 3 shows a second item of access information displayed on a display unit for the detection of a required sensor or actuator.

### DETAILED DESCRIPTION OF INVENTION

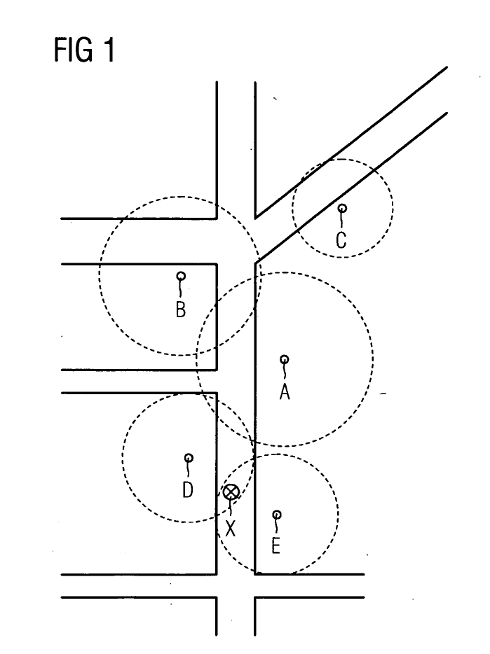

The operator's device according to the invention is used for the wireless control of sensors and/or actuators distributed in a system. The sensors and actuators are similarly able to communicate like the operator's device, i.e. they each comprise a transmit and receive unit. The operator's device has means for inputting data, e.g. a keyboard, a display unit, e.g. a monitor, a storage device as well as a program and processing unit. Positional data is stored in the storage device, e.g. coordinates relating to the exact position of the sensors and actuators in the system. Positional data for the routes leading to the sensors and actuators are also stored in the storage device, under which data a route plan is understood, as shown in accordance with FIG. 1.

FIG. 1 shows sensors and/or actuators A, B, C, D and E with the routes leading thereto.

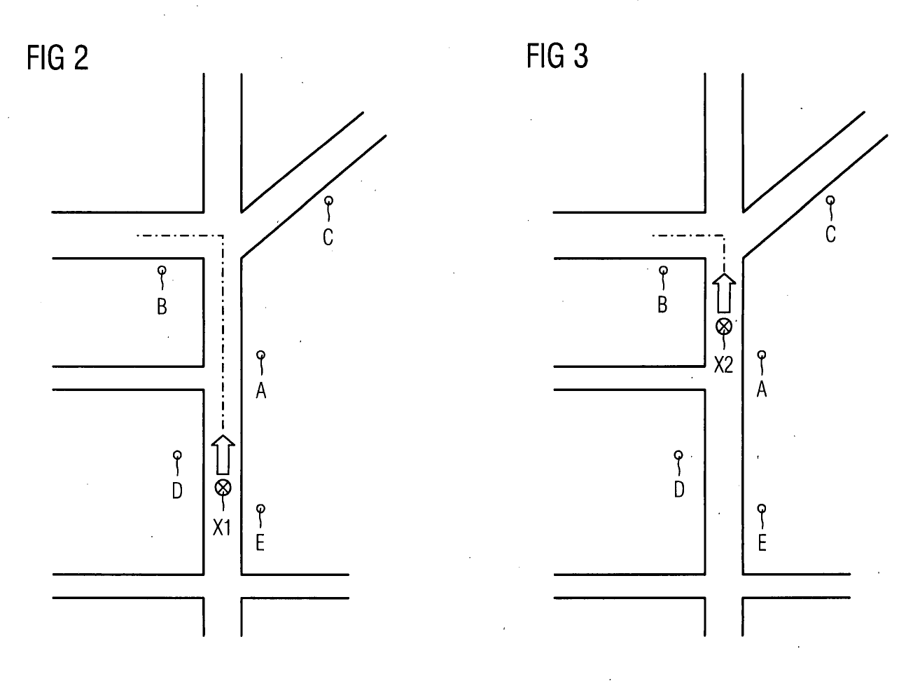

The sensors and actuators transmit signals with the aid of their transmit unit, which contain inter alia an item of identification data, e.g. an identification number or name, which is assigned to each sensor and actuator especially for identification purposes. The signals can be received by the operator's device in the service area illustrated in each instance by a concentric circle. The program and processing unit recognizes if an operator with the operator's device is located in one of the service areas of the sensors and/or actuators A, B, C D and E. If the operator's device receives signals of the sensors/actuators D, E at the same time for instance, it is thus located in the overlapping region of the service areas of D, E, i.e. at the position designated with X1 in accordance with FIG. 1. This is similarly determined by means of evaluation in the program and processing unit. In conjunction with the stored positional data for the sensors and actuators, it is possible to specify the route upon which a required sensor or actuator, e.g. the sensor B, can be detected. To this end, the operator inputs the required sensor B via the keyboard of the operator's device, whereupon after determining the position X1 on the display unit, a route plan with access information according to FIG. 2 is indicated. This route plan shows the momentary position X1′ as well as the access information by means of the arrow in order to reach the required sensor B. As apparent in FIG. 1, the route to sensor B is guided through service areas of the sensors/actuators D and A, with these still also partially overlapping. When the overlapping region of the sensor B and the sensor/actuator A has been reached, the new position X2 of the operator's device is determined by the program and processing unit and is shown on the route plan with the additional access information in accordance with FIG. 3.

The signals received by the sensors and/or actuators in their service area from the operator's device can, in addition to the identification data, still contain further information. Each signal has a certain signal strength for instance as a function of the distance from its source. When approaching the source, the signal strength increases and conversely when distancing from said source, the signal strength reduces. The detection of the signal strength and the evaluation of its change in the program and processing unit provides additional indications for the access information. For instance, the signal strength of sensor B is relatively minimal at position X2 according to FIG. 3 and increases in the direction of the arrow when the route is paced out (see also FIG. 1). In order to reach the sensor B, the operator with the operator's device must turn to his/her left, with the signal strength increasing still further.

In accordance with the invention, a method is also specified for the detection of a required sensor or actuator from several sensors and/or actuators distributed in a system. The sensors and actuators each have a transmit and receive unit here. With the aid of an operator's device which can communicate, the route to the required sensor or actuator is indicated. To this end, the operator's device has at least means for inputting data, a display unit, a storage device and a program and processing unit. Positional data, in particular coordinates for the precise positions of the individual sensors and/or actuators is stored in the storage device. Furthermore, positional data for the routes in the system leading to the sensors and/or actuators is also stored in the storage device. The inventive method essentially contains the following steps:
1. An item of identification data, e.g. an identification number or name, assigned to the required sensor or actuator is input by way of the data inputting means.
2. At least one signal received by a sensor or actuator is evaluated in the program and processing unit in conjunction with the positional data for the sensors/actuators stored in the storage device as well as for routes of the system and consequently access information for the detection of the required sensor or actuator is indicated on the display unit.

In the exemplary embodiment, coordinates and/or maps can be downloaded during the search by way of radio waves, i.e. wirelessly. It is also possible to wirelessly call up sensor information. The user creates the maps, in particular the route of the compartment for the operator's device. The creation of the map can take place both at the operator's device as well as also externally. The sensors are automatically incorporated into the system by crossing the compartment using radio waves. The actual position, related to the map, is continuously reentered anew and the operator's device and/or the software calculates the positions of the sensors. An inspection and corresponding changes can then be implemented.

1.-4. (canceled)

5. An operator's device for a wireless control of sensors and/or actuators, which are distributed in a system and which each comprise a transmit and receive unit, comprising:
a data input device;
a display unit to display access information for the detection of the sensor or actuator;
a storage device, wherein locating data are stored in the storage device; and
a program and processing unit to evaluate a signal received by a sensor or actuator in conjunction with the stored locating data for the actuators and/or sensors.

6. The operator's device as claimed in claim 5, wherein the locating data are positional data, wherein the positional data are coordinates for the positions of the individual sensors and/or actuators.

7. The operator's device as claimed in claim 5, wherein the locating data are routes in the system leading to the sensors and/or actuators.

8. The operator's device as claimed in claim 6, wherein the locating data are routes in the system leading to the sensors and/or actuators.

9. The operator's device as claimed in claim 5, wherein the program and processing unit determines an individual item of identification data for each sensor and/or actuator from the signal.

10. The operator's device as claimed in claim 6, wherein the program and processing unit determines an individual item of identification data for each sensor and/or actuator from the signal.

11. The operator's device as claimed in claim 7, wherein the program and processing unit determines an individual item of identification data for each sensor and/or actuator from the signal.

12. The operator's device as claimed in claim 8, wherein the program and processing unit determines an individual item of identification data for each sensor and/or actuator from the signal.

13. The operator's device as claimed in claim 5, wherein the program and processing unit determines the signal strength from the signal and evaluates this for the access information.

14. The operator's device as claimed in claim 6, wherein the program and processing unit determines the signal strength from the signal and evaluates this for the access information.

15. The operator's device as claimed in claim 7, wherein the program and processing unit determines the signal strength from the signal and evaluates this for the access information.

16. The operator's device as claimed in claim 8, wherein the program and processing unit determines the signal strength from the signal and evaluates this for the access information.

17. A method for a detection of a required sensor or actuator from several sensors and/or actuators distributed in a system, comprising:
providing sensors and/or actuators each of which comprise a transmit and receive unit;
providing an operator's device to communicate, which at least has a data input, a display unit, and a storage device;
assigning an item of identification data to the required sensor or actuator via the data input; and
evaluating at least one signal received by a sensor or actuator in conjunction with positional data for sensors/actuators stored in the storage device as well as for routes of the system and thereupon indicating an item of access information for the detection of the required sensor or actuator on the display unit.

18. The method as claimed in claim 17, wherein coordinates for the individual sensors and/or actuators as well as for routes in the system leading to the sensors and/or actuators are stored.

19. The method as claimed in claim 18, wherein the data stored are positional data.

20. The method as claimed in claim 17, wherein the identification data is an identification number or name.
